(19) United States
(12) Patent Application Publication
(10) Pub. No.: US 2001/0008525 A1
(43) Pub. Date: Jul. 19, 2001

(54) Process, exchange, service computer, program module and interface device for transmitting telecommunications service data between an exchange and a service computer

(76) Inventors: Peter Piepkorn, Tamm (DE); Heinrich Hopfmuller, Hemmingen (DE); Ingrid Glasner-Schapeler, Leonberg (DE); Thomas Milbredt, Leonberg (DE)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/753,462

(22) Filed: Jan. 4, 2001

(30) Foreign Application Priority Data
Jan. 15, 2000 (DE) 100 01 417.8

(51) Int. Cl. H04L 12/66

(52) U.S. Cl. 370/352; 370/401; 370/392

(57) ABSTRACT

The invention relates to a process for transmitting telecommunications service data between an exchange (SW1) and a service computer (GPTM), and furthermore an exchange (SW1), a service computer (GPTM), a program module and an interface device (LPTM) for this purpose. A subscriber (SUBA) with a terminal (TERA) can access a user interface (IGP) of the service computer (GPTM) via the Internet and can manipulate his telecommunications service data via the user interface (IGP). With the aid of telecommunications service data, the exchange (SW1) can provide telecommunications services. For this purpose it is proposed that a connection (VGP) is established between the exchange (SW1) and the service computer (GPTM) on which data for the provision of telecommunications services for the subscriber (SUBA) is transmitted in the form of objects, in particular in the form of CORBA objects or DCOM objects.

### DESCRIPTION

The present invention relates to a process according to the preamble of claim 1, a service computer according to the preamble of claim 7 for this purpose, a program module for a service computer according to the preamble of claim 8 for this purpose, an interface device for an exchange according to the preamble of claim 9 for this purpose, and an exchange according to the preamble of claim 10 for this purpose.

With advancing development, telecommunication networks offer their subscribers increasingly advanced telecommunications services with more added features. Such added feature telecommunications services are, for example, various forms of call diversion, in each case under certain conditions. Therefore with so-called call forwarding busy (CFB) for example, a call is only transferred to a different call number if the originally dialled call number is engaged. With so-called call forwarding unconditional (CFU) a call is transferred without a pre-condition to another call number. Such—partially standardised— services are common in ISDN networks (integrated services digital network) in particular, but also increasingly for subscribers with analogue connection to a public telephone network. The data required for such a service, for example a call number to which the call should be transferred, is generally managed decentrally in the local exchange via which the subscriber using the service is connected to the telecommunications network. Therefore a call can initially be routed to this local exchange which, with the aid of its locally stored data, can then transfer the call or reroute it to a pre-determined call number depending on the setting on the subscriber line.

The data for the last-mentioned services can be changed by the subscriber himself. The subscriber selects an access code on his telephone with which he gains access to his personal data and optionally inputs data changes, in other words activates a call diversion, for example, or deactivates it. The features for changing data and the range of data change possibilities are severely restricted by the limited operating possibilities on a conventional telephone, namely speech input, speech output and input via a keypad. Configuration of complicated services is virtually impossible by means of a conventional telephone. In the German patent application DE 198 10 869.9 a process is described, therefore, with which a subscriber can enter and configure by means of a terminal, in particular a personal computer, telecommunications services for himself, the data of which is substantially stored in a local exchange which serves his subscriber line.

In one of the solutions described in DE 198 10 869.9, the subscriber gains direct access to the local exchange via the Internet, in an alternative solution, indirectly via a service computer connected upstream of the local exchange. In this case, the local exchange and the service computer can, on the one hand, exchange telecommunications service data via a proprietary protocol defined specifically for communication between the local exchange and the service computer. On the other hand, the local exchange and the service computer can also communicate with one another, for example, via an interface conventional in telephone networks, thus via a Q3 interface in accordance with the specifications of the ITU (International Telecommunications Union) for example. A proprietary protocol on the one hand is difficult to define and on the other hand, can also only be understood by a local exchange adapted specifically to the proprietary protocol and the service computer pertaining thereto. Connection of different exchanges, in particular of exchanges supplied by different manufacturers, to a common service computer is, however, virtually impossible as not only the service computer but also each of the exchanges must be equipped with an interface module for the proprietary protocol. Communication via the standardised Q3 interface on the other hand permits only very limited configuration possibilities for telecommunications services as the standardised Q3 interface is designed specifically for communication between a so-called TMN-system (TMN= Telecommunications Network Management) and the exchanges to be controlled by the TMN-system. While exchanges can be basically controlled and monitored by the Q3 interface, the Q3 interface is not suitable for setting up new telecommunications services, in particular telecommunications services which have not yet been standardised, or even for interactive provision of telecommunications services through an exchange and a service computer.

It is therefore the object of the invention to allow efficient and flexible communication between an exchange and a service computer via which a subscriber can manipulate telecommunications service data to be provided for him through the exchange via the Internet with the aid of a terminal.

This object is achieved by a process according to the technical teaching of claim 1, a service computer according to the technical teaching of claim 7, a program module for a service computer according to the technical teaching of claim 8, an interface device for an exchange according to the technical teaching of claim 9 and an exchange according to the technical teaching of claim 10. Further advantageous effects of the invention emerge from the dependent claims and the description.

The invention is based on the idea that an exchange and a service computer establish a connection via which data is transmitted in the form of objects for the provision of telecommunications services. The service computer offers a subscriber a user interface for manipulation of his telecommunications service data via the Internet with a terminal. The exchange provides telecommunications services with the aid of the telecommunications service data or data produced therefrom by the service computer, which data is transmitted on the connection between the exchange and the service computer in the form of objects. By transmitting the data in objects, the respective communications partner is given access to a precisely defined range of functions. Incorrect or unauthorised access to telecommunications service data is prevented.

The telecommunications service data transmitted in the form of objects can on the one hand be configuration settings with which it is established which telecommunications services and in which form the exchange is to provide telecommunications services for the subscriber. Communication via objects also opens up the possibility, however, that the service computer and the exchange transmit data with which the exchange and the service computer can provide telecommunications services interactively.

The objects for communication between the exchange and the service computer can on the one hand be designed according to individually defined specifications or else, in an advantageous variation of the invention, can be so-called object-request-broker objects, for example in accordance with the CORBA specification (CORBA=Common Object Request Broker Architecture) from the OMG (Object Management Group) or the DCOM specification from Microsoft. By keeping to such common and open object-request-broker specifications it is easily possible to connect diverse exchanges—even those from different manufacturers—to one service computer.

Whilst an interface for object communication with the service computer can be an integral component of the exchange, a further advantage emerges, however, when an object interface module is used for connection to the service computer, which module is connected upstream of a service provision module of the exchange which module is already present anyway in the exchange for the provision of telecommunications services. Owing to the modular addition of the object interface module, the configuration data of the service provision module can alternatively be manipulated by the subscriber, at least in part, via a telephone connection as well.

A plurality of exchanges can also communicate with the service computer via the object interface of the service computer. The service computer need not necessarily recognise an actual spatial arrangement of the exchanges or their physical addresses. The service computer can in fact query the respective object reference of the exchange in a further variation of the invention opened up by communication with objects in a so-called name server with the aid of a logic address of the respective exchange. The object reference contains, for example, the respective physical address, for example an Internet address of the exchange, via which the service computer can address objects to the exchange. An allocation of an exchange to a plurality of service computers is also possible. Owing to communication by means of object references a very high level of abstraction is achieved which facilitates not only the creation of programs for the provision and configuration of telecommunications services but also the maintenance and servicing of the systems, in other words the exchanges according to the invention and the service computer or computers according to the invention during operation.

The invention and its advantages will be illustrated below with the aid of embodiments and the drawings.

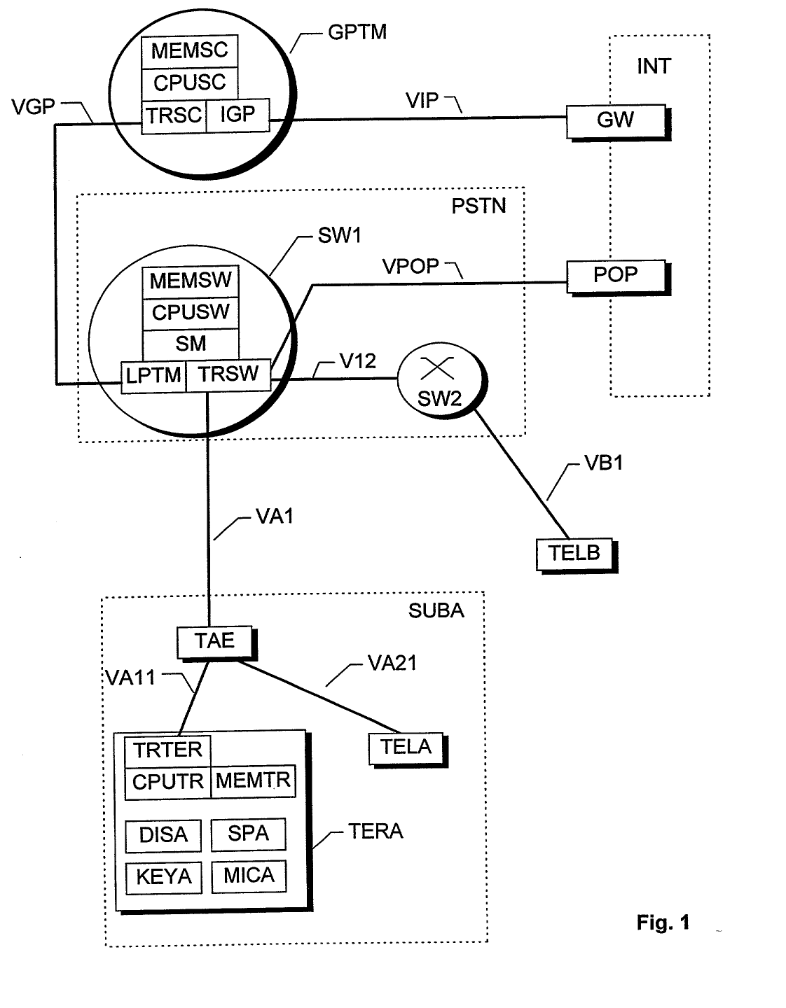

FIG. 1 shows an arrangement for carrying out the process according to the invention with a terminal TERA, an exchange SW1 according to the invention and a service computer GPTM according to the invention.

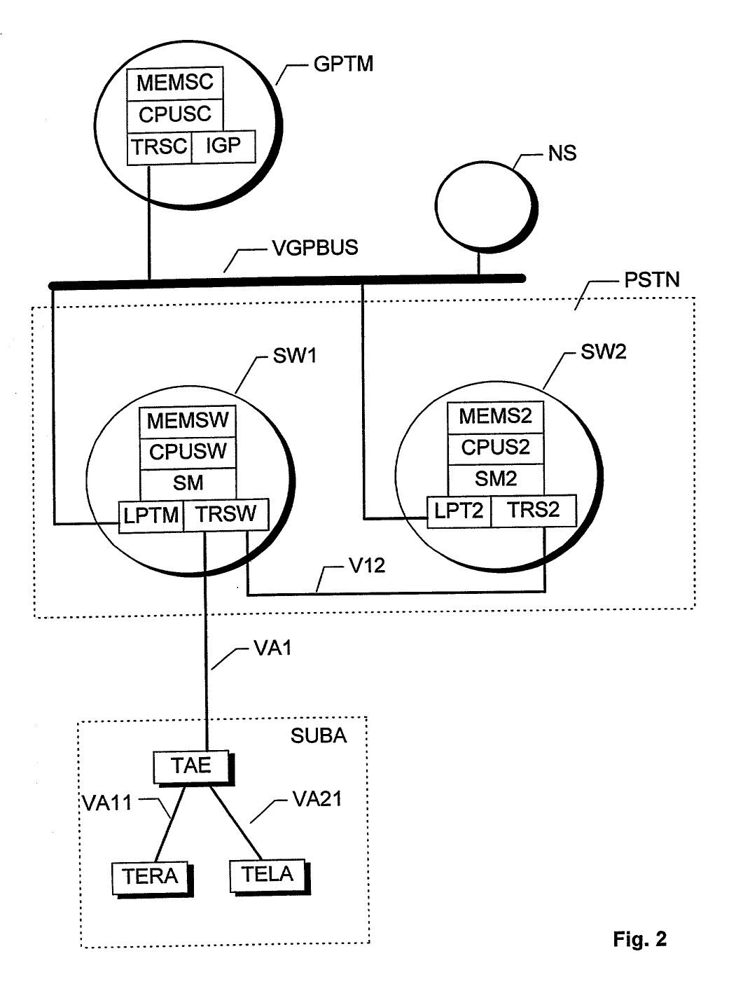

FIG. 2 shows a preferred development of the arrangement from FIG. 1 for carrying out the process according to the invention with the terminal TERA, exchanges SW1 and SW2 according to the invention and the service computer GPTM.

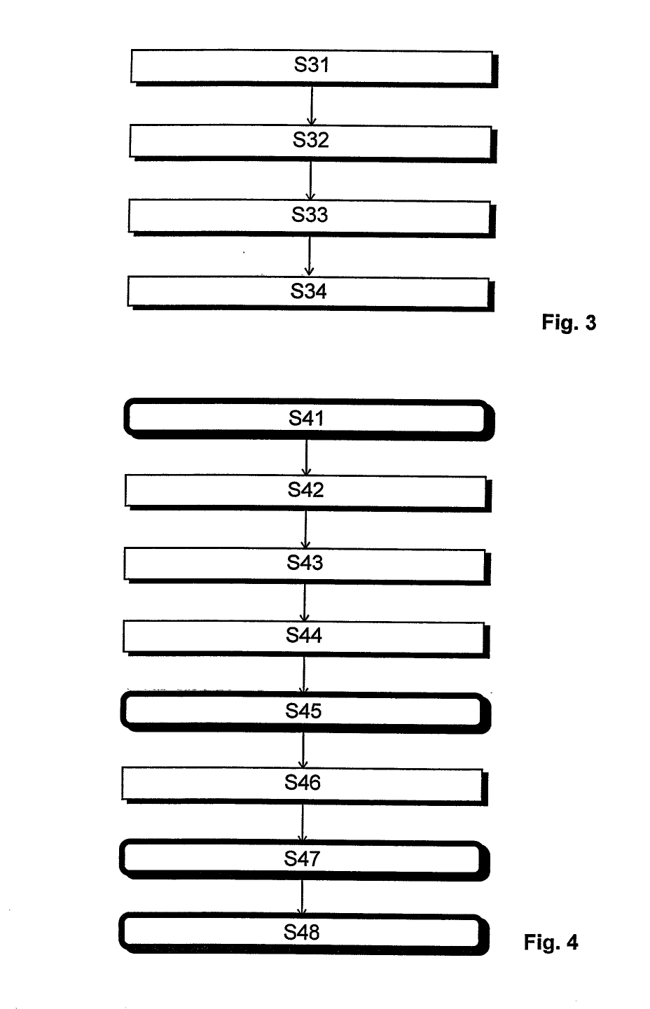

FIG. 3 shows a flow chart with essential stages of the process according to the invention.

FIG. 4 shows a flow chart of a communication between the exchange SW1 and the service computer GPTM from FIG. 1.

FIG. 1 shows by way of example a very schematic arrangement with which the invention can be carried out. FIG. 1 shows a telecommunications network PSTN, the Internet INT and a subscriber SUBA indicated in each case by a dotted box. The subscriber SUBA has a terminal TERA according to the invention and a further terminal TELA which can, for example, be a fixed network telephone or mobile radio telephone. The terminal TERA is a fixed network telephone in the example of FIG. 1 and is connected via an access line VA11 to a subscriber access socket TAE. The terminal TELA is connected via an alternative access line VA21 to the subscriber access socket TAE. The subscriber access socket TAE terminates a subscriber access line VA1 which leads to the exchange SW1.

The terminal TERA is, for example, a personal computer. The terminal TERA can however also be a mobile radio telephone terminal or a fixed network telephone with which access to the Internet is possible in each case. The terminal TERA has connection means TRTER which is, for example, a modem or an ISDN adapter. With the connection means TRTER the terminal TERA can establish a connection to the Internet INT via the telecommunications network PSTN. Furthermore, the terminal data equipment TERA has control means CPUTR and a memory MEMTR. The control means CPUTR is, for example, a processor with which the program code which is stored in the memory MEMTR can be implemented. The memory MEMTR is a hard disc or consists of RAM chips for example. Furthermore, the terminal TERA has display means DISA and input means KEYA. The display means DISA is, for example, a computer monitor or a LCD display (liquid crystal display). The input means KEYA can be a keyboard or a mouse. Furthermore, the terminal TERA has a loud speaker SPA and a microphone MICA with which speech outputs and inputs are possible. It is also possible that the terminal TERA is a combination device which can also carry out the functions of the terminal TELA, of a telephone in other words.

The exchange SW1 according to the invention and an exchange SW2 are shown in place of further devices not shown in FIG. 1 of the telecommunications network PSTN which can be an analogue telecommunications network, an ISDN telecommunications network (integrated services digital network) or else a mobile radio telephone network. The exchanges SW1 and SW2 are connected to one another via a connecting line V12. The connecting line V12 can be a group of channels between the two exchanges. It is also possible however that the connection V12 extends over further exchanges of the telecommunications network PSTN not illustrated in FIG. 1.

Some essential components of the exchange SW1 are shown by way of example, namely an interface device LPTM, service provision means SM, connecting means TRSW and control means CPUSW and a memory MEMSW which are connected to one another by connections not shown in FIG. 1. The exchange SW1 can establish data and speech connections to subscribers or other exchanges with the connecting means TRSW. The service provision means SM can provide telecommunications services for the subscribers connected to the exchange SW1, control a call diversion for example. The subscriber SUBA can influence the functions of the service provision means SM in that he establishes a connection to the connecting means TRSW with the terminal TELA for example. The subscriber SUBA can then send commands for the alteration of configuration settings to the service provision means SM via this connection by inputting characters on a keyboard of the terminal TELA, not shown in FIG. 1. The control means CPUSW is a processor or a group of processors which can carry out commands which are stored in the memory MEMSW. The control means CPUSW controls the functions of the exchange SW1 and in the process influences the functions of the connecting means TRSW for example. Furthermore, the exchange SW1 can have further modules, for example an interface to a network management system. The exchange SW2 can, as will become clear in FIG. 2, also be equipped internally like the exchange SW1. The exchange SW2 can however also be a conventionally known exchange. The exchange SW1 can assume the functions of a local exchange. It is also possible, however, that the exchange SW1 assumes central functions for exchanges connected downstream, not shown in FIG. 1, which exchanges can be located on the connection V12, or that the subscriber access line VA1 is connected to an exchange or front-end equipment upstream of the exchange SW1.

A service computer GPTM is connected via connecting means TRSC and a connection VGP to the exchange SW1. The service computer GPTM has control means CPUSC and memory MEMSC. The service computer GPTM can establish a connection VIP to the Internet with connecting means IGP. The service computer GPTM can be a computer which is operated by a UNIX operating system or a Windows-NT operating system. The control means CPUSC is a processor or a cluster of processors which carry out the commands of the operating system, which operating system is stored in the memory MEMSC. Furthermore, program code sequences can be stored in the memory MEMSC, which comprises, for example, a hard disc or RAM chips, which sequences are carried out by the control means CPUSC. The control means CPUSC also influence the functions of the connecting means TRSC with which the above-mentioned connection VGP can be established for example. The service computer GPTM also has further modules, not illustrated in FIG. 1, for example a monitor, a keyboard and a mouse. The service computer GPTM can also serve further exchanges apart from the exchange SW1.

Only the access device POP and a gateway GW are illustrated for the Internet INT. The further infrastructure of the Internet INT, for example routers, gateways and the like are not illustrated in FIG. 1 for reasons of simplicity.

A typical process sequence will now be illustrated below with the aid of the arrangement from FIG. 1 and the flowchart from FIG. 3.

The subscriber SUBA establishes a connection to the access device POP of the Internet INT with his terminal TERA in a stage S31. For this purpose, the subscriber SUBA inputs the subscriber number to the access device POP on the input means KEYA. The terminal TERA then establishes a connection to the exchange SW1 via the access line VA11 and the subscriber access line VA1. With the aid of the subscriber number to the access device POP, the exchange SW1 then completes the desired connection of the subscriber SUBA and in addition establishes the further connection VPOP to the access device POP. The subscriber can communicate with a user interface provided by the service computer GPTM via the Internet INT. In the process, telecommunications service data is transmitted in a stage S32 from the terminal TERA via a gateway GW and via a connection VIP to the service computer GPTM and vice versa. With the aid of the data, settings can be read out from the telecommunications services and changed. Additional telecommunications services can be requested or the operating parameters of telecommunications services already entered can be changed in this case for example. It is therefore possible, for example, to enter various forms of call diversion such as the call forwarding busy (CFB) or the call forwarding unconditional (CFU) mentioned at the start. New types of services described in more detail further below can also be installed which can be provided interactively by the service computer GPTM with the exchange SW1. So the subscriber SUBA can only access telecommunications service data if he is authorised to do so, a so-called “firewall”, not shown in FIG. 1, can be connected upstream of the service computer GPTM, which firewall prevents the subscriber SUBA looking at or manipulating data which he is not allowed access to. Furthermore, the service computer GPTM can have a blocking function with which the service computer GPTM prevents the subscriber SUBA accessing his telecommunications service data not only with the terminal TERA but simultaneously with a further terminal not illustrated in FIG. 1.

The user interface is provided by a program which is stored in the memory MEMSC and is implemented by the control means CPUSC. The user interface sends data in the page description language hypertext markup language (HTML), the expanded page description language XML (extensible markup language) or else in the language JAVA, for example, to the terminal TERA, which data is read and interpreted by the terminal TERA by means of an evaluation program, a so-called browser. The program code of the browser is stored in the memory MEMTR and is implemented by the control means CPUTR. The subscriber SUBA can modify the data shown by the browser. The terminal TERA sends the modified data back to the service computer GPTM.

In a stage S33 the service computer GPTM establishes a connection VGP to the exchange SW1. The connection VGP can be produced, for example, via a so-called virtual private network (VPN) which can be a private logical network established on the telecommunications network PSTN or the Internet INT. Instead of being produced via the telecommunications network PSTN the connection VGP can however also be produced via the Internet or, for security reasons, via a separate local area network (LAN). The service computer GPTM then transmits the telecommunications service data modified by the terminal TERA on the connection VGP in a stage S34 in the form of objects, for example in the form of CORBA objects. For the transmission of objects, the Internet inter object request broker protocol (IIOP) defined by the above-mentioned OMG can then be used which can be transmitted in the context of the TCP/IP (TCP/IP=transmission control protocol/Internet protocol).

On the one hand it is possible that the service computer GPTM converts the data sent by the terminal TERA into objects only and converts data sent by the exchange SW1, for example input requests, from objects into a form which can be evaluated by the terminal TERA. The service computer GPTM is transparent in this case for the values of the data. On the other hand, it is also possible however, that the service computer GPTM initially stores the telecommunications service data during a communication in the memory MEMSC using the terminal TERA and subsequently transmits changes in the telecommunications service data to the exchange SW1 in the form of objects. Furthermore, the telecommunications service data and similar data of other subscriber lines, terminal TELB connected via a subscriber access line VB1 to the exchange SW2 for example, can be stored temporarily or permanently in the memory MEMSC. The service computer GPTM then provides the user interface function for a plurality of exchanges and at the same time provides a common telecommunications service database and function base for these exchanges. An example thereof is illustrated in FIG. 2.

FIG. 2 substantially shows the arrangement known from FIG. 1, wherein the terminal TERA is illustrated in simplified form however and the terminal TELB is omitted completely. Furthermore, the Internet INT, the elements gateway GW and access device POP pertaining thereto and the corresponding connections VPOP and VIP are no longer illustrated there for the sake of clarity. Instead, the exchange SW2 is shown in more detail. The exchange SW2 is integrated in FIG. 2 like the exchange SW1 with the service computer GPTM in a manner according to the invention. A control means CPUS2 performs similar functions in the exchange SW2 to the control means CPUSW, a memory MEMS2 performs similar functions to the memory MEMSW, connecting means TRS2 performs similar functions to the connecting means TRSW and an interface device LPT2 performs similar functions to the interface device LPTM. Unlike in FIG. 1, the exchange SW1 is not connected via an end-to-end connection VGP to the service computer GPTM but rather the exchange SW1 and the exchange SW2 are connected via their interface devices LPT2 and LPTM to a common bus VGPBUS via which the exchange SW1 and the exchange SW2 send telecommunications service data in the form of objects to the service computer GPTM connected via the connecting means TRSC to the bus VGPBUS and can receive data therefrom. The individual spur lines of the exchange SW1, of the exchange SW2, of the service computer GPTM and of a name server NS to the bus VGPBUS are not shown in more detail in FIG. 2. The bus VGPBUS can be both an actual bus, for example a LAN (local area network) or a WAN (wide area network), and also a logical bus which is installed via the Internet or via a VPN on the telecommunications network PSTN.

The name server NS is a computer which stores and manages the network elements connected to the bus VGPBUS—so-called object references—centrally. Each new network element to be connected to the bus VGPBUS, in other words the exchange SW2 in comparison with FIG. 1 for example, logs in after its connection with the name server NS, i.e., the network element sends the name server NS its logical name, for example “SW2”, at least and an actual physical network address, for example an Internet address. If the service computer GPTM now wishes to send an object with telecommunications service data to the exchange SW2 the service computer GPTM initially enquires, with the aid of the logical name “SW2”, in the name server NS under which object reference the exchange SW2 can be reached. This object reference contains inter alia the physical network address of the exchange SW2 with the aid of which the service computer GPTM can then send objects to the exchange SW2. Likewise, the exchange SW2 can query the object reference of the service computer GPTM in the name server NS in the reverse direction when the exchange SW2 wishes to send objects to the service computer GPTM. The increasing mobility of subscribers can also be taken into account with the aid of the invention in that not only the object references of the exchanges SW1 and SW2 but also object references of the subscribers connected thereto are stored in the name server NS. It is then no longer necessary for example that it be noted in the service computer GPTM whether the subscriber SUBA is currently connected to the exchange SW1 or temporarily to the exchange SW2. Owing to the abstraction stages attained in this way, the telecommunications service data in the service computer GPTM is easy to manage on the one hand, on the other hand the software of the service computer GPTM for managing and exploiting the telecommunications service data can be created more easily and more independently of the infrastructure of the telecommunications network PSTN actually present.

The interface device LPTM can be an integral component of the exchange SW1—also in the form of a computer module—or can be integrated directly into the service provision means SM. It is also possible however that the interface device LPTM is a computer upstream of the exchange SW1 which is operated by a UNIX operating system for example, and exchanges data with the exchange SW1 via a LAN for example. The service provision means SM can on the one hand be manipulated by the terminal TELA in a known manner as described above, in particular when the service provision means SM is separate from the interface device LPTM, in other words a modular structure is chosen, on the other hand it can be manipulated very comfortably via the Internet, the service computer GPTM and the interface device LPTM by the terminal TERA. The interface device LPTM converts the objects called up by the service computer GPTM into commands which can be interpreted by the service provision means SM and in the opposite direction converts messages of the service provision means SM into objects. The service provision means SM need not be modified in this case for the new type of communication according to the invention with the service computer GPTM.

Furthermore, new types of functions which go beyond the previous functions of the service provision means SM can also be implemented easily with the aid of the interface device LPTM. Owing to communication in objects not only data for configuring telecommunications services can be transmitted particularly comfortably, but also telecommunications services can be provided in cooperation with the exchange SW1 and the service computer GPTM. Such a service is, for example, the so-called “virtual fax service” in which the telecommunications network PSTN, for example, receives a fax instead of a fax machine belonging to the subscriber SUBA when the subscriber does not have a fax machine connected to the subscriber access line VA1. When the exchange SW1 receives a fax message intended for the subscriber SUBA on the connection V12 for example, the connecting means TRSW forward the fax message to the service provision means SM which forwards the fax message to the interface device LPTM. The interface device LPTM then converts the fax message into an object which the interface device LPTM sends to the service computer GPTM on the bus VGPBUS. This stores the fax message-object in its memory MEMSC for later retrieval by the subscriber SUBA. It is also possible however that further computers are connected to the service computer GPTM for providing such services.

FIG. 4 shows a sequence of a communication between the exchange SW1 and the service computer GPTM in communication stages S41, S42, S43, S44, S45, S46, S47 and S48 by way of example. The communication stages S41, S45, S47 and S48 are shown bordered by thick lines and with rounded corners in order to indicate that data is manipulated in these communication stages in the exchange SW1, while the communication stages S42, S43, S44 and S46 show with thinner lines such communication stages in which the service computer GPTM only queries data in the exchange SW1.

When the subscriber SUBA accesses the user interface of the service computer GPTM in the manner above-described via his terminal TERA, the service computer GPTM retrieves an object “Manage DN Profile” of the exchange SW1 with which the exchange SW1 is requested to install an access block for a subscriber number (DN=directory number) given by the service computer GPTM so the same subscriber data cannot be accessed from another point during the process which now follows. In the communication stage S42 the service computer GPTM then queries an object “GetServiceList” in the exchange SW1 in which the telecommunications services installed for the subscriber SUBA are given. In an optional communications stage S43, the service computer GPTM can learn via an object “GetAIIMSNs” from the exchange SW1 which additional call numbers, so-called “multiple subscriber numbers” (MSNs) are installed for the subscriber access line VA1 if the subscriber access line VA1 is an ISDN subscriber access line. In the communications stage S44, the service computer GPTM learns from the exchange SW1 via an object “GetAccessType” whether the subscriber access line VA1 is operated in an analogue manner or via an ISDN protocol, for example 1TR6 or E-DSS1. The service computer GPTM can also learn in the process that the subscriber access line VA1 is a mobile radio telephone connection. In the communications stage S45 the service computer GPTM then installs a new telecommunications service in the exchange SW1 via an object “SetServiceSubscription” when one is requested by the subscriber SUBA. In the communications stage S46 the service computer GPTM queries the exchange SW1 with an object “GetServiceDetails” the parameters for the telecommunications service optionally installed in the communication stage S45 or another telecommunications service already previously installed. In communications stage S47 the service computer GPTM modifies the parameters queried in communication stage S46 via an object “ModifyServiceDetails”, in other words, activates a call diversion for example or changes the destination number given for this in accordance with the subscriber's SUBA instructions at the terminal TERA. Finally, in a communications stage S48 the service computer GPTM sets a so-called trigger point in the exchange SW1 with an object “ManageINTrigger”. Owing to such a trigger point the exchange SW1 can be induced in the event of an incoming call for the subscriber access line while this is engaged owing to an Internet session of the terminal TERA, to request the service computer GPTM or a service computer of an intelligent network (IN), a so-called SCP (service control point), to provide a telecommunications service. Then the service computer sends a message via the Internet to the terminal TERA that there is a call for the subscriber SUBA for example.

The service computer GPTM can also provide its above-described functions according to the invention with the aid of a program module which is stored in the memory MEMSC and can be implemented by the control means CPUSC. According to the instructions of the program module, the service computer GPTM then controls inter alia the functions of the connecting means TRSC which can, for example, be a so-called “socket” of a UNIX operating system operating the service computer GPTM. It is also possible that the service computer GPTM communicates with the exchange SW1 and with the exchange SW2 via objects constructed differently in each case or via objects with different capabilities. The service computer GPTM can also so be integrated in the exchange SW1. The memory MEMSW then additionally fulfils the functions of the memory MEMSC, the control means CPUSW fulfils the functions of the control means CPUSC and the connecting means TRSW fulfil the function of the connecting means TRSC.

1. Process for transmitting telecommunications service data between an exchange (SW1) and a service computer (GPTM), wherein a subscriber (SUBA) with a terminal (TERA) can access a user interface (IGP) of the service computer (GPTM) via the Internet, wherein the subscriber can manipulate telecommunications service data via the user interface (IGP) and wherein the exchange (SW1) can provide telecommunications services with the aid of the telecommunications service data, characterised in that a connection (VGP) is established between the exchange (SW1) and the service computer (GPTM), and in that data for providing telecommunications services for the subscriber is transmitted on the connection between the exchange (SW1) and the service computer (GPTM) in the form of objects.

2. Process according to claim 1, characterised in that the objects are transmitted between the exchange and the service computer as object-request-broker objects.

3. Process according to claim 1, characterised in that an interface module (LPTM) is used for the connection (VGP) to the service computer (GPTM), which interface module is connected upstream of a service provision module (SM) of the exchange (SW1), of which the data for providing telecommunications services can also be manipulated by the subscriber via a telephone connection.

4. Process according to claim 1, characterised in that the service computer (GPTM) determines the object reference of the exchange (SW1) or in that the exchange (SW1) determines the object reference of the service computer (GPTM) with the aid of a name server, and in that the objects are transmitted between the exchange (SW1) and the service computer (GPTM) with the aid of the respective object reference.

5. Process according to claim 1, characterised in that the service computer (GPTM) of the exchange (SW1) transmits configuration settings for telecommunications services as data for the provision of telecommunications services.

6. Process according to claim 1, characterised in that the service computer (GPTM) and the exchange (SW1) transmit, as data for the provision of telecommunications services, data with which the exchange (SW1) and the service computer (GPTM) can provide telecommunications services interactively.

7. Service computer (GPTM) for transmitting
telecommunications service data between an exchange (SW1) and the service computer (GPTM), the service computer (GPTM) having a user interface (IGP) which a subscriber (SUBA) with a terminal (TERA) can access via the Internet and via which the subscriber can manipulate telecommunications service data with the aid of which the exchange (SW1) can provide telecommunications services, characterised in that the service computer (GPTM) has memories (MEMSC) which are designed in such a way that the service computer (GPTM) can store the telecommunications services data, in that the service computer (GPTM) has connecting means (TRSC) which are designed in such a way that the service computer (GPTM) can establish a connection (VGP) to the exchange (SW1), and in that the connecting means (TRSC) are furthermore designed in such a way that the service computer (GPTM) can transmit data for the provision of telecommunications services for the subscriber on the connection to the exchange (SW1) in the form of objects.

8. Program module for a service computer (GPTM) for transmitting telecommunications service data between an exchange (SW1) and the service computer (GPTM) which has a user interface (IGP) which a subscriber (SUBA) with a terminal (TERA) can access via the Internet and via which the subscriber can manipulate telecommunications service data with the aid of which the exchange (SW1) can provide telecommunications services, the program module containing a program code which can be implemented by a control means (CPUSC) of the service computer (GPTM), characterised in that the program module is designed in such a way that the service computer (GPTM) can store the telecommunications service data in a memory (MEMSC) in accordance with the instructions of the program module, in that the program module has connecting means which are designed in such a way that the service computer (GPTM) can establish a connection (VGP) to the exchange (SW1) in accordance with the instructions of the program module, and in that the connecting means are furthermore designed in such a way that the service computer (GPTM) can transmit data for the provision of telecommunications services for the subscriber on the connection to the exchange (SW1) in the form of objects in accordance with the instructions of the program module.

9. Interface device (LPTM) for an exchange (SW1) for transmitting telecommunications service data between the exchange (SW1) and a service computer (GPTM) which has a user interface (IGP) which a subscriber (SUBA) with a terminal (TERA) can access via the Internet and via which the subscriber can manipulate telecommunications service data which can be used for the provision of telecommunications services by a service provision means (SM) of the exchange (SW1), characterised in that the interface device (LPTM) has connecting means which are designed in such a way that the interface device (LPTM) or the service computer (GPTM) can establish a connection (VGP) between the exchange (SW1) and the service computer (GPTM), and in that the interface device (LPTM) has transmitting and receiving means which are designed in such a way that the interface device (LPTM) can transmit data for the provision of telecommunications services for the subscriber through the exchange (SW1) on the connection between the exchange (SW1) and the service computer (GPTM) in the form of objects.

10. Exchange with an interface device (LPTM) for
transmitting telecommunications service data between the exchange (SW1) and a service computer (GPTM) which has a user interface (IGP) which a subscriber (SUBA) with a terminal (TERA) can access via the Internet and via which the subscriber can manipulate telecommunications service data which can be used for the provision of telecommunications services by a service provision means (SM) of the exchange (SW1), characterised in that the interface device (LPTM) has connecting means which are designed in such a way that the interface device (LPTM) or the service computer (GPTM) can establish a connection (VGP) between the exchange (SW1) and the service computer (GPTM), and in that the interface device (LPTM) has transmitting and receiving means which are designed in such a way that the interface device (LPTM) can transmit data for the provision of telecommunications services for the subscriber through the exchange (SW1) on the connection between the exchange (SW1) and the service computer (GPTM) in the form of objects.
